(19) United States
(12) Patent Application Publication
(10) Pub. No.: US 2019/0000700 A1
(43) Pub. Date: Jan. 3, 2019

(54) HOSPITAL BED WITH INFLATABLE BLADDERS AND COOLING CHANNELS AND RELATED METHODS

(71) Applicant: ENCOMPASS GROUP, LLC., MCDONOUGH, GA (US)

(72) Inventors: MICHELLE DANIELS, MCDONOUGH, GA (US); EVAN CALL, CENTERVILLE, UT (US)

(21) Appl. No.: 16/023,319

(22) Filed: Jun. 29, 2018

Related U.S. Application Data
(60) Provisional application No. 62/526,457, filed on Jun. 29, 2017.

(51) Int. Cl. A61G 7/057; A47C 27/08; A47C 21/04

(52) U.S. Cl. CPC A61G 7/05769; A47C 27/083; A47C 21/044; A47C 27/088

(57) ABSTRACT

A hospital bed may include a support structure, a controller, a pressure source coupled to the controller, and a hospital bed mattress carried by the support structure. The hospital bed mattress is carried by the support structure and has first and second ends, and first and second sides extending between the first and second ends. The hospital bed mattress may include a base foam layer, and transverse bladder pairs extending over the base foam layer and being coupled to the pressure source. The transverse bladder pairs may extend between the first and second sides and may be configured to provide longitudinal pressure differential and lateral pressure differential. The hospital bed mattress may have a multi-layer removable encasement surrounding the base foam layer and the transverse bladder pairs.

### RELATED APPLICATION

This application is based upon prior filed Provisional Patent Application No. 62/526,457 filed Jun. 29, 2017, the entire subject matter of which is incorporated herein by reference in its entirety.

### TECHNICAL FIELD

The present disclosure relates to the field of hospital equipment, and, more particularly, to a hospital bed and related methods.

### BACKGROUND

A modern hospital is a complex specialized service provider. Given the nature of the service being provided, the typical modern hospital is stocked with a multitude of medical devices. Although many of these medical devices were developed in the last 50 years, for example, the magnetic resonance imaging (MRI) device, there are some medical devices that have been mainstays in hospitals for well over a century. One such long lived medical device is the hospital bed.

In their earliest incarnation, hospital beds were largely identical to typical beds, but in the early 1800s, early approaches added adjustable side rails to the beds. Subsequently, wheels were added to the hospital bed to permit easy movement for bedridden patients. In the mid-1900s, the modern three-segment hospital bed became available. This hospital bed was motorized and permitted adjustment of the foot section, midsection, and head section of the bed. Additional features added to hospital beds include bed exit alarms, and a “CPR” mode for administration of cardiopulmonary resuscitation (CPR).

Another aspect of the hospital bed that has received attention is the hospital bed mattress, also known as a therapeutic mattress or medical mattress. The hospital bed mattress is designed to accommodate the person lying on it and to be able to move with the head, foot and height adjustments of which hospital beds are capable, i.e. it needs to be flexible. Another feature in hospital bed mattresses is bed sore prevention. One approach to this feature is to provide a plurality of air bladders within the hospital bed mattress, which are activated to change pressure points on a patient's skin.

### SUMMARY

Generally, a hospital bed may include a support structure, a controller, a pressure source coupled to the controller, and a hospital bed mattress carried by the support structure. The hospital bed mattress is carried by the support structure and has first and second ends, and first and second sides extending between the first and second ends. The hospital bed mattress may comprise a base foam layer, and a plurality of transverse bladder pairs extending over the base foam layer and being coupled to the pressure source. The plurality of transverse bladder pairs may extend between the first and second sides and may be configured to provide longitudinal pressure differential and lateral pressure differential. The hospital bed mattress may comprise a multi-layer removable encasement surrounding the base foam layer and the plurality of transverse bladder pairs.

In some embodiments, the base foam layer may comprise opposing first and second ends, the first end to receive a head of a patient, the second end to receive feet of the patient. The base foam layer may include an upper major surface and a lower major surface opposing the upper major surface. The upper major surface may comprise a plurality of upper ribs, and a plurality of upper slots. The lower major surface may comprise a plurality of lower ribs, and a plurality of lower slots. The plurality of lower ribs may be vertically aligned with the plurality of upper slots, and the plurality of lower slots may be vertically aligned with the plurality of upper ribs.

Also, the multi-layer removable encasement may include a top coating layer, a spacer layer under the top coating layer, an elastane layer under the spacer layer, and a breathable fabric layer under the elastane layer. The multi-layer removable encasement may comprise a plurality of valves fluidly coupled to the pressure source, and each valve of the plurality of valves may be configured to open when a patient imparts pressure thereon.

More specifically, each transverse bladder pair of the plurality of transverse bladder pairs may comprise first and second overlapping bladders. Each of the first and second overlapping bladders may have a triangle-shape. The hospital bed may also further comprise a plurality of handles extending outward from the first and second sides of the hospital bed mattress. The base foam layer may comprise a rigid foam.

Another aspect is directed to a method of making a hospital bed. The method comprises providing a support structure, coupling a pressure source to a controller, and positioning a hospital bed mattress to be carried by the support structure and having first and second ends, and first and second sides extending between the first and second ends. The hospital bed mattress may include a base foam layer, and a plurality of transverse bladder pairs extending over the base foam layer and being coupled to the pressure source. The plurality of transverse bladder pairs may extend between the first and second sides and configured to provide longitudinal pressure differential and lateral pressure differential. The hospital bed mattress may include a multi-layer removable encasement surrounding the base foam layer and the plurality of transverse bladder pairs.

### BRIEF DESCRIPTION OF THE DRAWINGS

FIG. 1 is a schematic diagram of a hospital bed, according to the present disclosure.

FIG. 2 is a schematic cross-sectional view of the hospital bed along a transverse sectional line, according to the present disclosure.

FIG. 3 is a schematic exploded view of another embodiment of the hospital bed, according to the present disclosure.

FIGS. 4A and 4B are schematic diagrams of an example embodiment of the support structure of hospital bed, according to the present disclosure.

FIG. 5A is a schematic diagram of another example embodiment of the support structure of hospital bed, according to the present disclosure.

FIGS. 5B and 5C are enlarged portions of the support structure of hospital bed from FIG. 5A.

FIG. 6 is a schematic diagram of hospital bed mattress from the hospital bed, according to the present disclosure.

FIG. 7 is a schematic diagram of another example embodiment of the hospital bed, according to the present disclosure.

FIG. 8 is a schematic diagram of a transverse bladder pair from the hospital bed of FIG. 7.

### DETAILED DESCRIPTION

The present disclosure will now be described more fully hereinafter with reference to the accompanying drawings, in which several embodiments of the present disclosure are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

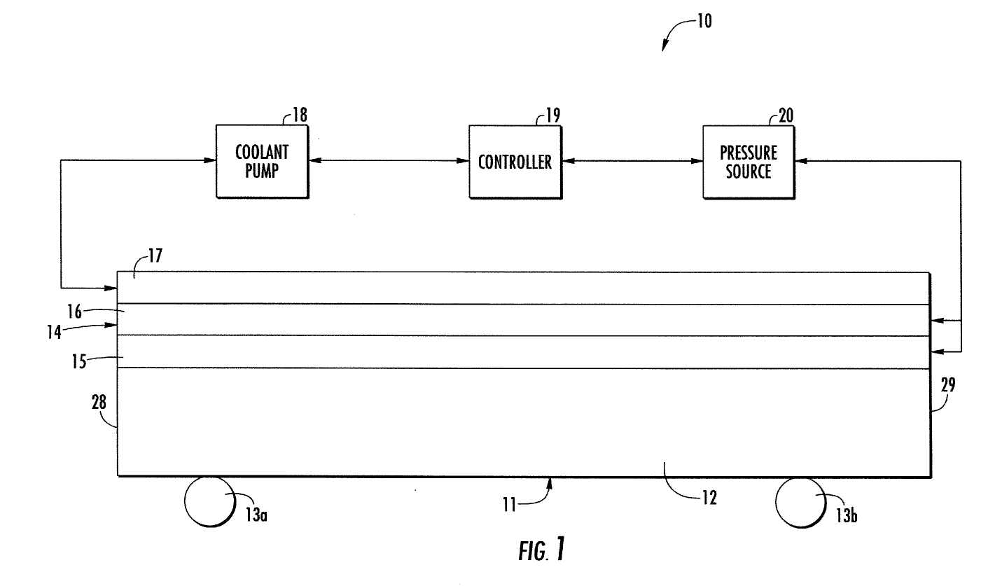

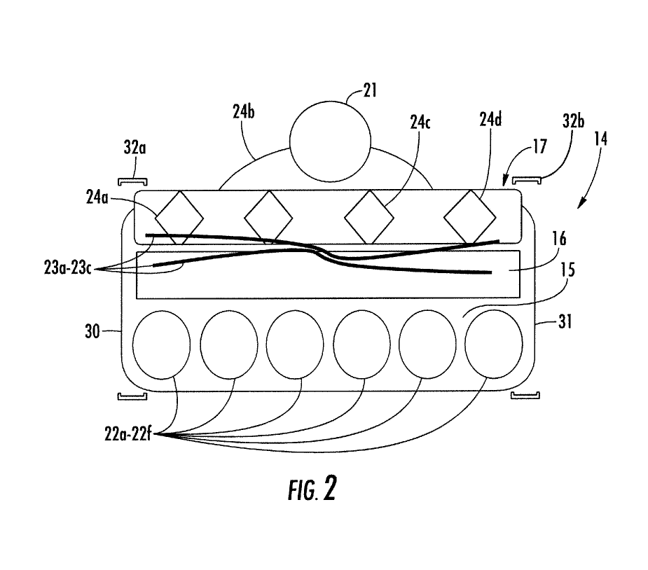

Referring initially to FIGS. 1-2, a hospital bed 10 according to the present disclosure is now described. The hospital bed 10 illustratively includes a support structure 11. The support structure 11 illustratively includes a base portion 12, and a plurality of wheels 13a-13b coupled to the base portion. As will be appreciated by those skilled in the art, the support structure 11 may adjust positions of the head section, the midsection, and the foot section of the base portion 12. Also, the support structure 11 may adjust the height of the base portion 12. The hospital bed 10 illustratively includes a controller 19, a pressure source 20 (e.g. air compressor device) coupled to the controller, and a coolant pump 18 coupled to the controller.

The controller 19 may comprise logic circuitry configured to control the pressure source 20 and the coolant pump 18. In other embodiments, the hospital bed 10 includes a control panel (not shown) coupled to the controller 19 and configured to permit user selected activity of the pressure source 20 and the coolant pump 18. The control panel may include a plurality of switches for manipulating the hospital bed 10. The hospital bed 10 may also include a wireless transceiver (not shown, e.g. WiFi (IEEE 802.11 variant), Bluetooth, ZigBee (IEEE 802.15.4)) coupled to the controller 19 and configured to permit remote control and/or monitoring of the hospital bed 10.

The hospital bed 10 illustratively includes a hospital bed mattress 14 carried by the support structure 11 and having first and second ends 28, 29, and first and second sides 30, 31 extending between the first and second ends. The hospital bed mattress 14 is configured to receive a patient 21 on an upper surface thereof. The hospital bed mattress 14 illustratively includes a plurality of longitudinal bladders 22a-22f coupled to the pressure source 20 and extending between the first and second ends 28, 29 and configured to provide lateral pressure differential. The hospital bed mattress 14 illustratively includes a base foam layer 15 carrying the plurality of longitudinal bladders 22a-22f. The base foam layer 15 may include a rigid foam.

The hospital bed mattress 14 illustratively includes a plurality of transverse bladders 23a-23c coupled to the pressure source 20 and extending between the first and second sides 30, 31. The plurality of transverse bladders 23a-23c is configured to provide longitudinal pressure differential. The hospital bed mattress 14 illustratively includes a first medial layer 16 carrying the plurality of transverse bladders 23a-23c. The plurality of transverse bladders 23a-23c and the plurality of longitudinal bladders 22a-22f are overlapping.

As will be appreciated by those skilled in the art, the plurality of longitudinal bladders 22a-22f and the plurality of transverse bladders 23a-23c are controlled via the controller 19 to prevent bed sore incidence in the patient 21 and to aid with movement of the patient for repositioning and removal from the hospital bed mattress 14. The hospital bed mattress 14 includes a plurality of tubes (not shown) coupled between the pressure source 20, and the plurality of longitudinal bladders 22a-22f and the plurality of transverse bladders 23a-23c.

In some embodiments, the controller 19 is configured to divide the plurality of longitudinal bladders 22a-22f into a plurality of sections, and the controller is configured to control each section individually and separately from other sections. Each section may comprise one or more individual bladders. Also, the controller 19 is configured to divide the plurality of transverse bladders 23a-23c into a plurality of sections, and the controller is configured to control each section individually and separately from other sections. Advantageously, the controller 19 may be configured to selectively activate sections of the plurality of longitudinal bladders 22a-22f and sections of the plurality of transverse bladders 23a-23c to provide alternating pressure therapy to the patient 21.

The plurality of transverse bladders 23a-23c may comprise accordion bellows configured to extend vertically between first and second major surfaces of the hospital bed mattress 14. In fact, in some embodiments, each transverse bladder 23a-23c comprises a set of accordion bellows (i.e. each section here comprises a single accordion bellows) being aligned and extending between the first and second sides 30, 31 of the hospital bed mattress 14. These embodiments more readily impart longitudinal pressure differential to the patient 21.

Also, the controller 19 is configured to selectively control inflation and deflation of each accordion bellows, and to coordinate deflation of respective accordion bellows above longitudinal bladders 22a-22f being inflated. This feature insures that the longitudinal bladders 22a-22f being inflated do not impart too much lateral pressure differential on the patient 21.

The hospital bed mattress 14 illustratively includes a plurality of channels 24a-24d coupled to the coolant pump 18. The plurality of channels 24a-24d is adjacent an upper surface of the hospital bed mattress 14 and configured to circulate a coolant fluid. The hospital bed mattress 14 illustratively includes a convoluted foam layer 17 carrying the plurality of channels 24a-24d.

Additionally, each channel 24a-24d illustratively includes a rectangle-shaped tube (i.e. a cross-sectional shape). In other embodiments, the plurality of channels 24a-24d may have other shapes, such as a circle-shaped tube, or a square-shaped tube.

Helpfully, the plurality of channels 24a-24d may provide for a cooling feature for the patient 21. In particular, the thermal energy from the patient 21 is transferred to the coolant fluid and exited the hospital bed mattress 14.

The coolant pump 18 is configured to recirculate the coolant fluid through the plurality of channels 24a-24d, and to exhaust thermal energy removed from the patient 21. In some embodiments, the coolant pump 18 may include an active refrigeration element to further reduce the temperature of the coolant fluid as it recirculates.

For example, the coolant fluid may comprise at least one of air and water. In one embodiment, the coolant fluid comprises air, and the coolant pump 18 may comprise an air pump, which may be integrated with or separate from (as in the illustrated embodiment) the pressure source 20. The coolant pump 18 may be coupled to the plurality of channels 24a-24d via a plurality of tubes (not shown).

The hospital bed mattress 14 illustratively includes first and second rails 32a-32b configured to retain the patient 21. Helpfully, the first and second rails 32a-32b may prevent accidental falls. In particular, the firm first and second rails 32a-32b as part of the design of the foam crib will assist with ingress and egress, and will reduce the falls that can occur with air only surfaces as patients are sitting on the side of the bed for therapy intervention or in preparation for ingress and egress.

Another aspect is directed to a method for making a hospital bed 10. The method may include providing a support structure 11, coupling a pressure source 20 to a controller 19, and positioning a hospital bed mattress 14 to be carried by the support structure. The hospital bed mattress may have first and second ends 28, 29, and first and second sides 30, 31 extending between the first and second ends. The hospital bed mattress 14 may comprise a plurality of longitudinal bladders 22a-22f coupled to the pressure source 20 and extending between the first and second ends 28, 29 and configured to provide lateral pressure differential, a plurality of transverse bladders 23a-23c coupled to the pressure source and extending between the first and second sides 30, 31 and configured to provide longitudinal pressure differential, and a plurality of channels 24a-24d adjacent an upper surface of the hospital bed mattress 14 and configured to circulate a coolant fluid.

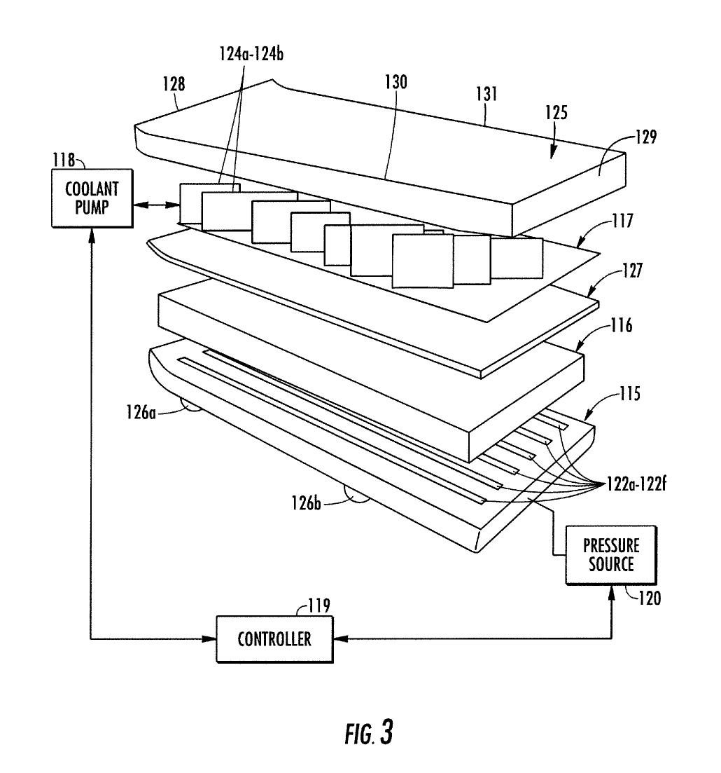

Referring now additionally to FIG. 3, another embodiment of the hospital bed 110 is now described. In this embodiment of the hospital bed 110, those elements already discussed above with respect to FIGS. 1-2 are incremented by 100 and most require no further discussion herein. This embodiment differs from the previous embodiment in that this hospital bed 110 illustratively includes a plurality of handles 126a-126b extending outward from the first and second sides 130, 131 of the hospital bed mattress 114. The plurality of handles 126a-126b is mounted onto the base foam layer 115, which is rigid in this embodiment. Advantageously, the plurality of handles 126a-126b is configured to permit emergency evacuation of the patient, i.e. carrying the patient out on the hospital bed mattress 114 separated from the support structure.

The hospital bed 110 illustratively includes a cover layer 125, and a second medial layer 127 under the convoluted foam layer 117. The cover layer 125 comprises material configured to accommodate stretching, heat wicking, low friction, and low shear risk.

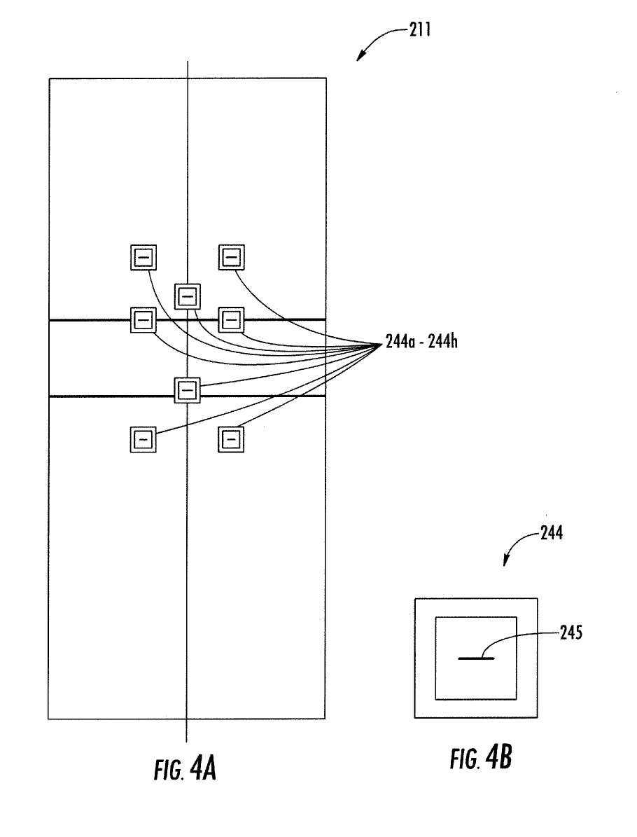

Referring now additionally to FIGS. 4A-4B, another embodiment of the hospital bed 210 is now described. In this embodiment of the hospital bed 210, those elements already discussed above with respect to FIGS. 1-3 are incremented by 200 and most require no further discussion herein.

The support structure 211 illustratively includes a plurality of pressure interjection ports 244a-244h. Each of the plurality of pressure interjection ports 244a-244h is individually fluidly coupled to the pressure source. Each of the plurality of pressure interjection ports 244a-244h illustratively includes a cutout 245 comprising a short slit configured to permit coupling to the pressure source.

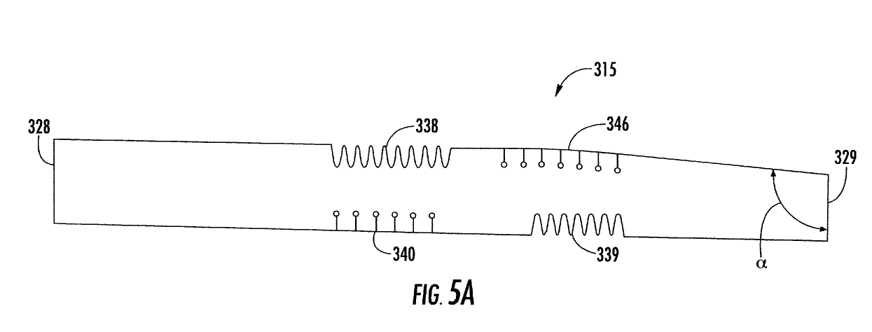

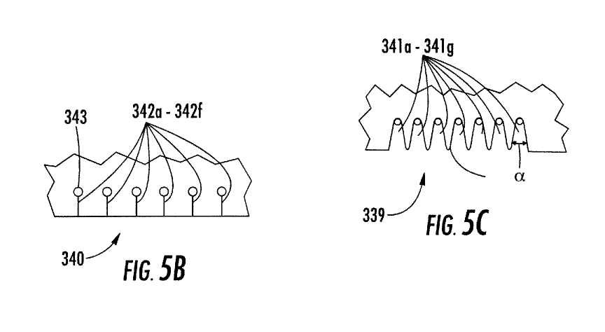

Referring now additionally to FIGS. 5A-5C, another embodiment of the base foam layer 315 is now described. In this embodiment of the base foam layer 315, those elements already discussed above with respect to FIGS. 1-3 are incremented by 300 and most require no further discussion herein. The second end 329 of the base foam layer 315 illustratively includes a decline, and receives the feet of the patient. The first end 328 is flat and receives the head of the patient. Typically, the heels are a common site for bed sore incidence. Because of the thin layers of tissue, underlying bone prominence, limited blood supply and anatomical design. The decline in the second end may provide an increased load on the calve of the leg so that the decreased load of pressure on the heels may be reduced, thereby reducing incidence of bed sores.

In the illustrated embodiment, the decline is at an angle of 4.1° (illustrative example and can vary ±2°) with respect to a longitudinal axis of the base foam layer 315, and the internal angle α of 94.1° (illustrative example and can vary ±2°). The base foam layer 315 illustratively includes an upper surface, and an opposing lower surface. The upper surface illustratively includes a section 338 comprising a plurality of ribs. Advantageously, the base foam layer 315 provides a foam “crib” that provides supportive assistance but allows flexibility to align therapy with the function of the supporting frame. This may reduce the risk of injury from entrapment or ejection as the surface increases in distance from the protective rails of the supporting frame.

The lower surface illustratively includes a section 339 comprising a plurality of ribs 341a-341g. Adjacent ribs are divided by a valley delineated by straight opposing sides, terminating at curved end with an angle α between 15°-45° (illustrative example is 20°) and a depth of 1.75-2.25 inches (i.e. about 15-30% of the depth of the base foam layer 315). The section 338 on the upper surface is similarly constituted. The curved end may have a radius of 0.20-0.30 inches. Gatching on the bottom of the foam rail surface may support the stability for seat assist (when the bed frame is in the seat assist position), but allow for the flexibility in moving with the frame as needed for the flex of the head of bed adjustment, as well as a contoured profiling frame.

The lower surface illustratively includes a section 340 comprising a plurality of slots 342a-342f. Each of the plurality of slots 342a-342f extends transversely between sides of the base foam layer 315, and extends from the lower surface at a substantially perpendicular angle (i.e. ±15° of 90°). Each of the plurality of slots 342a-342f terminates with a circular recess 343 (e.g. having a radius between 0.15 and 0.3 inches) within the base foam layer 315, and extends vertically between 1.50 and 2.00 inches (i.e. about 15-25% of the depth of the base foam layer 315). The upper surface illustratively includes a section 346 comprising a plurality of slots, which is similarly constituted to the section 340 on the lower surface.

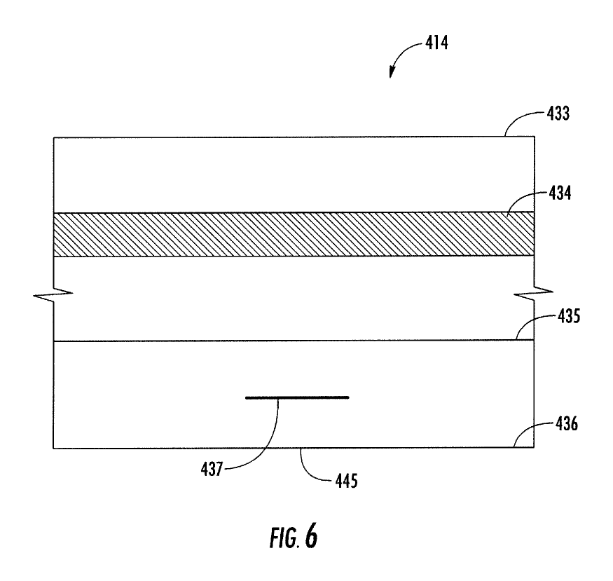

Referring now additionally to FIG. 6, another embodiment of the hospital bed mattress 414 is now described. In this embodiment of the hospital bed mattress 414, those elements already discussed above with respect to FIGS. 1-3 are incremented by 400 and most require no further discussion herein. As seen in FIG. 6, another embodiment of an uppermost portion of the hospital bed mattress 414 is shown. The uppermost portion of hospital bed mattress 414 illustratively includes (working from the top layer in a downward direction) a top coating layer 433 of breathable material (as available from the Dartex division of Trelleborg Industri AB of Trelleborg, Sweden), a foam or spacer layer 434 of fabric, a lycra (i.e. elastane) layer 435, a valve layer 437 (only 1 depicted for illustrative clarity), and a breathable waterproof fabric layer 436 with cutouts 445 (only 1 depicted for illustrative clarity) for the pressure interjection ports. It should be appreciated that the uppermost portion of hospital bed mattress 414 comprises a plurality of valve layers and cutouts 445. Each of the plurality of valve layers 437 is attached to the lycra layer 435, for example, via tacking, stitching or adhesive material.

In some embodiments, the valve layer 437 is only partial, and comprises a plurality of square shaped cutouts (e.g. 3 inch×3 inch square) positioned over valves. Also, each of the cutouts 445 may comprise a short slit, i.e. approximately 1.25 inches long, and terminated with rip stop stitching. Also, the valve layer 437 may comprise a low friction material, such as, for example, GlideWear dual layer low friction material, as available from Tamarack Habilitation Technologies, Inc. of St. Paul, Minn.

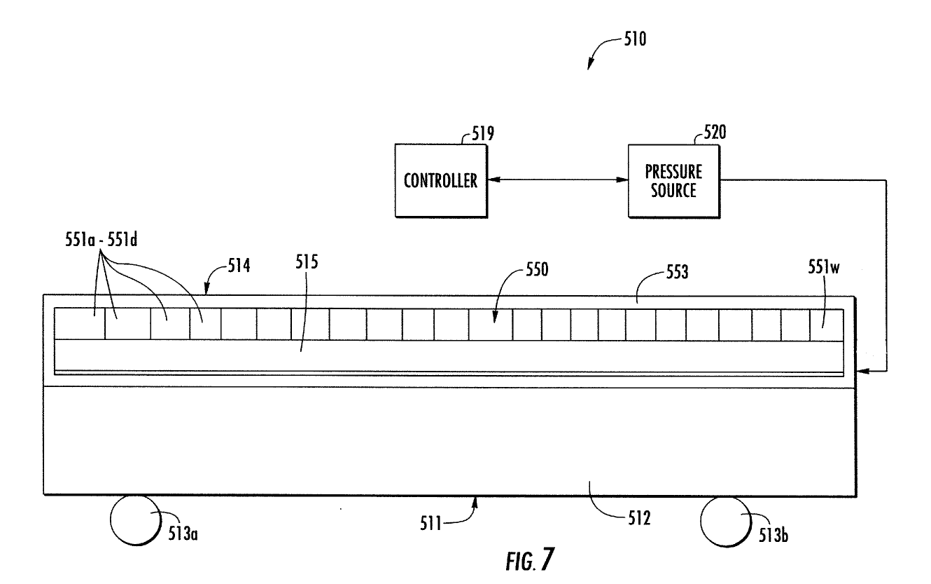

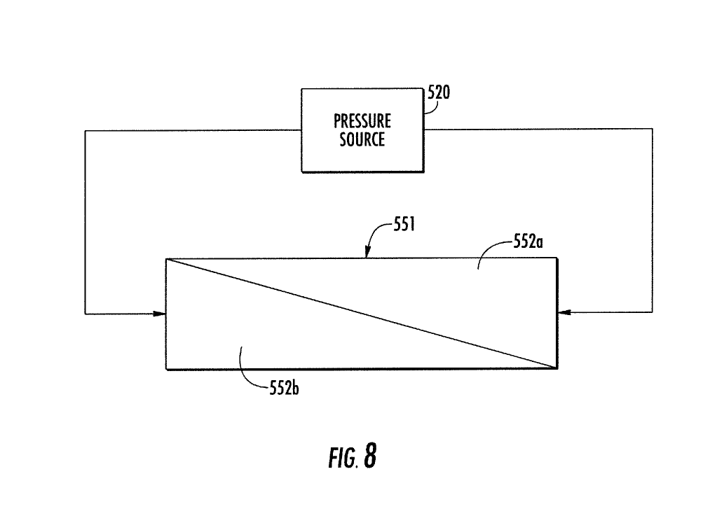

Referring now additionally to FIGS. 7-8, another embodiment of the hospital bed 510 is now described. In this embodiment of the hospital bed 510, those elements already discussed above with respect to FIGS. 1-2 are incremented by 500 and most require no further discussion herein. This embodiment differs from the previous embodiment in that this hospital bed 510 illustratively does not include the coolant pump, the plurality of longitudinal bladders, the medial base layer, nor the convoluted foam layer of the embodiments noted above. Nevertheless, it should be appreciated that other embodiments could include these features, and that any of the above described features from the embodiments of FIGS. 1-6 could be added to the embodiment of FIGS. 7-8.

Here, the hospital bed 510 illustratively includes a support structure 511, a controller 519, a pressure source 520 coupled to the controller, and a hospital bed mattress 514 carried by the support structure. The hospital bed mattress 514 is carried by the support structure 511. The hospital bed mattress 514 illustratively includes first and second ends, and first and second sides extending between the first and second ends. The hospital bed mattress 514 illustratively includes a base foam layer 515, and a plurality of transverse bladder pairs 551a-551w extending over the base foam layer and being coupled (e.g. via hoses) to the pressure source 520. The plurality of transverse bladder pairs 551a-551w illustratively extends between the first and second sides and is configured to provide longitudinal pressure differential and lateral pressure differential. The hospital bed mattress 514 illustratively includes a multi-layer removable encasement 553 surrounding the base foam layer 515 and the plurality of transverse bladder pairs 551a-551w.

Although not shown, the hospital bed mattress 514 may include a peripheral frame extending around and carrying the plurality of transverse bladder pairs 551a-551w. The peripheral frame would also be surrounded by the multi-layer removable encasement 553.

The base foam layer 515 is constituted similarly to the base foam layer 315 shown in FIGS. 5A-50. The base foam layer 515 illustratively includes opposing first and second ends. The first end is to receive a head of a patient, and the second end is to receive the feet of the patient. The base foam layer 515 illustratively includes an upper major surface and a lower major surface opposing the upper major surface. The upper major surface comprises a plurality of upper ribs 338, and a plurality of upper slots 346. The lower major surface comprises a plurality of lower ribs 339, and a plurality of lower slots 340. The plurality of lower ribs 339 is vertically aligned with the plurality of upper slots 346, and the plurality of lower slots 340 is vertically aligned with the plurality of upper ribs 338. Helpfully, the base foam layer 515 is able to support the patient, and the hospital bed mattress 514 during prolonged power loss and during emergency evacuation of the patient.

The multi-layer removable encasement 553 is constituted similarly to the uppermost portion of the hospital bed mattress 414 shown in FIG. 6. The multi-layer removable encasement 553 illustratively includes a top coating layer 433, a spacer layer 434 under the top coating layer, an elastane layer 435 under the spacer layer, and a breathable fabric layer 436 under the elastane layer. Although not shown, the multi-layer removable encasement 553 may include a closable opening (e.g. zipper, hook and loop interface) extending along one of the first and second sides, permitting it to be removed and to be fitted over the base foam layer 515 and the plurality of transverse bladder pairs 551a-551w.

In some embodiments, the multiple layers 433-436 extend around all sides of the multi-layer removable encasement 553. In other embodiments, on the upper layer includes the multiple layers 433-436.

The multi-layer removable encasement 553 illustratively includes a plurality of valves 437 fluidly coupled to the pressure source 520, and each valve of the plurality of valves is configured to open when a patient imparts pressure thereon. For example, in some embodiments, the plurality of valves can be positioned similarly to the plurality of pressure interjection ports 244a-244h in FIGS. 4A-4B.

Indeed, in some embodiments, each of the plurality of valves 437 comprises a short slit, i.e. approximately 1.25 inches long, and terminated with rip stop stitching. When the patient applies pressured, the slit opens permitting airflow. Helpfully, this permits the uppermost areas about the patient to air cooled and dried, reducing the chances of skin injury.

In the illustrated embodiment, each transverse bladder pair 551a-551w of the plurality of transverse bladder pairs comprises first and second overlapping bladders 552a-552b. Each of the first and second overlapping bladders 552a-552b illustratively includes a triangle-shape. Helpfully, overlapping, triangle bladders remove the line of traditional bladder adjustment in alternation inflation and deflation and may allow for gradual deflation to support the prevention of shear injury risk.

Positively, this arrangement permits both longitudinal pressure differential and lateral pressure differential. In particular, the longitudinal pressure differential is generated by selectively inflating different transverse bladder pairs 551a-551w. The transverse pressure differential is generated by selectively inflating only one of the first and second overlapping bladders 552a-552b in multiple different transverse bladder pairs 551a-551w. In some embodiments, each of the first and second overlapping bladders 552a-552b comprises the inflatable bladders disclosed in U.S. Pat. No. 8,102,270 to Gowda et al., the contents of which are hereby incorporated by reference in their entirety.

Another aspect is directed to a method of making a hospital bed 510. The method comprises providing a support structure 511, coupling a pressure source 520 to a controller 519, and positioning a hospital bed mattress 514 to be carried by the support structure and having first and second ends, and first and second sides extending between the first and second ends. The hospital bed mattress 514 includes a base foam layer 515, and a plurality of transverse bladder pairs 551a-551w extending over the base foam layer and being coupled to the pressure source 520. The plurality of transverse bladder pairs 551a-551w extends between the first and second sides and configured to provide longitudinal pressure differential and lateral pressure differential. The hospital bed mattress 514 includes a multi-layer removable encasement 553 surrounding the base foam layer 515 and the plurality of transverse bladder pairs 551a-551w.

Advantageously, the hospital bed embodiments disclosed herein may reduce the incidence of bed sores/ulcers in the patient. This benefit is derived from the alternating pressure therapy provided by the transverse and longitudinal bladders and the fabric composition of the hospital bed mattress.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

That which is claimed is:

1. A hospital bed comprising:
a support structure;
a controller;
a pressure source coupled to said controller; and
a hospital bed mattress carried by said support structure and having first and second ends, and first and second sides extending between the first and second ends, said hospital bed mattress comprising
a base foam layer,
a plurality of transverse bladder pairs extending over said base foam layer and being coupled to said pressure source, said plurality of transverse bladder pairs extending between the first and second sides and configured to provide longitudinal pressure differential and lateral pressure differential, and
a multi-layer removable encasement surrounding said base foam layer and said plurality of transverse bladder pairs.

2. The hospital bed of claim 1 wherein said base foam layer comprises opposing first and second ends, the first end to receive a head of a patient, the second end to receive feet of the patient; wherein said base foam layer comprises an upper major surface and a lower major surface opposing said upper major surface; and wherein said upper major surface comprises a plurality of upper ribs, and a plurality of upper slots.

3. The hospital bed of claim 2 wherein said lower major surface comprises a plurality of lower ribs, and a plurality of lower slots, the plurality of lower ribs being vertically aligned with said plurality of upper slots, the plurality of lower slots being vertically aligned with said plurality of upper ribs.

4. The hospital bed of claim 1 wherein said multi-layer removable encasement comprises a top coating layer, a spacer layer under said top coating layer, an elastane layer under said spacer layer, and a breathable fabric layer under said elastane layer.

5. The hospital bed of claim 1 wherein said multi-layer removable encasement comprises a plurality of valves fluidly coupled to said pressure source; and wherein each valve of said plurality of valves is configured to open when a patient imparts pressure thereon.

6. The hospital bed of claim 1 wherein each transverse bladder pair of said plurality of transverse bladder pairs comprises first and second overlapping bladders.

7. The hospital bed of claim 6 wherein each of said first and second overlapping bladders has a triangle-shape.

8. The hospital bed of claim 1 further comprising a plurality of handles extending outward from the first and second sides of said hospital bed mattress.

9. The hospital bed of claim 1 wherein said base foam layer comprises a rigid foam.

10. A hospital bed comprising:
a support structure;
a controller;
a pressure source coupled to said controller; and
a hospital bed mattress carried by said support structure and having first and second ends, and first and second sides extending between the first and second ends, said hospital bed mattress comprising
a base foam layer,
a plurality of transverse bladder pairs extending over said base foam layer and being coupled to said pressure source, said plurality of transverse bladder pairs extending between the first and second sides and configured to provide longitudinal pressure differential and lateral pressure differential, and
a multi-layer removable encasement surrounding said base foam layer and said plurality of transverse bladder pairs,
said multi-layer removable encasement comprising
a top coating layer,
a spacer layer under said top coating layer,
an elastane layer under said spacer layer,
a breathable fabric layer under said elastane layer, and
a plurality of valves fluidly coupled to said pressure source and being between said elastane layer and said breathable fabric layer, each valve of said plurality of valves configured to open when a patient imparts pressure thereon.

11. The hospital bed of claim 10 wherein said base foam layer comprises opposing first and second ends, the first end to receive a head of the patient, the second end to receive feet of the patient; wherein said base foam layer comprises an upper major surface and a lower major surface opposing said upper major surface; and wherein said upper major surface comprises a plurality of upper ribs, and a plurality of upper slots.

12. The hospital bed of claim 11 wherein said lower major surface comprises a plurality of lower ribs, and a plurality of lower slots, the plurality of lower ribs being vertically aligned with said plurality of upper slots, the plurality of lower slots being vertically aligned with said plurality of upper ribs.

13. The hospital bed of claim 10 wherein each transverse bladder pair of said plurality of transverse bladder pairs comprises first and second overlapping bladders.

14. The hospital bed of claim 13 wherein each of said first and second overlapping bladders has a triangle-shape.

15. The hospital bed of claim 10 further comprising a plurality of handles extending outward from the first and second sides of said hospital bed mattress.

16. The hospital bed of claim 10 wherein said base foam layer comprises a rigid foam.

17. A method of making a hospital bed comprising:
providing a support structure;
coupling a pressure source to a controller; and
positioning a hospital bed mattress to be carried by the support structure and having first and second ends, and first and second sides extending between the first and second ends, the hospital bed mattress comprising
a base foam layer,
a plurality of transverse bladder pairs extending over the base foam layer and being coupled to the pressure source, the plurality of transverse bladder pairs extending between the first and second sides and configured to provide longitudinal pressure differential and lateral pressure differential, and
a multi-layer removable encasement surrounding the base foam layer and the plurality of transverse bladder pairs.

18. The method of claim 17 wherein the base foam layer comprises opposing first and second ends, the first end to receive a head of a patient, the second end to receive feet of the patient; wherein the base foam layer comprises an upper major surface and a lower major surface opposing the upper major surface; and wherein the upper major surface comprises a plurality of upper ribs, and a plurality of upper slots.

19. The method of claim 18 wherein the lower major surface comprises a plurality of lower ribs, and a plurality of lower slots, the plurality of lower ribs being vertically aligned with the plurality of upper slots, the plurality of lower slots being vertically aligned with the plurality of upper ribs.

20. The method of claim 17 wherein the multi-layer removable encasement comprises a top coating layer, a spacer layer under the top coating layer, an elastane layer under the spacer layer, and a breathable fabric layer under the elastane layer.
